(19) United States
(12) Patent Application Publication
(10) Pub. No.: US 2022/0007669 A1
(43) Pub. Date: Jan. 13, 2022

(54) METHOD FOR MAKING TEA CUBES USING MICRONIZED TEA AND TEA CUBES MADE BY THE METHOD

(71) Applicant: Tata Consumer Products Limited, Kolkata (IN)

(72) Inventors: Vikas Gupta, Kolkata (IN); Sudeendra U R, Kolkata (IN); Umesh R, Kolkata (IN)

(73) Assignee: Tata Consumer Products Limited, Kolkata (IN)

(21) Appl. No.: 17/435,796

(22) PCT Filed: Feb. 4, 2020
(86) PCT No.: PCT/IN2020/050111

§ 371 Date: Sep. 2, 2021

(30) Foreign Application Priority Data
Feb. 5, 2019 (IN) 201931004564

(51) Int. Cl. A23F 3/22

(52) U.S. Cl. CPC A23F 3/22

(57) ABSTRACT

A method for making tea cubes containing a blend of granular sugar, dry extract of either black or green teas, micronized tea and flavour comprises providing tea leaves that have been micronized in a jet mill (1) to simulate performance of instant tea without contributing any stickiness. Next, sugar and flavour are prepared for mixing and incorporating them with micronized tea. The particle size distribution of sugar is decided depending upon the percentage (%) of non-sugar ingredients in the cube formulation.

This application claims priority from Indian provisional patent application no. 201931004564 dated 5 Feb. 2019 and the disclosure therein is referred to here in its entirety.

### FIELD OF THE INVENTION

The present invention relates in general to methods for quick tea-making and in particular to a method for making tea cubes comprising a blend of granular sugar, dry extract of either black or green teas, micronized tea and flavour. The tea cubes yield excellent tea in the quickest time, leaving no or negligible residue for disposal.

### BACKGROUND AND PRIOR ART

Tea bags, which are consumed in the brewed protocol, are well known in the art for quick and relatively simple preparation of tea. Tea cubes can be a good alternative for tea bags. The cubes can dissolve instantly both in hot water and cold water and offer a great tasting product which contains minimal calories (under 16 calories).

Users of tea bags are familiar with their drawbacks. While it does provide a way for quick preparation of tea, the end product, i.e., tea produced from teabags always involves labour and time, as water must be brought to boiling temperature before tea bags can be used.

Moreover, there are other irritants like disposal of used tea bags containing tea leaves. Tea bags are not fully disposable after use.

Thus, there is a great need in the field for a medium which can produce excellent quality tea in exciting flavour range very quickly and easily and to do away with the disadvantages associated with tea bags.

The present invention seeks to fulfil these requirements of the prior art.

### OBJECTS OF THE INVENTION

Accordingly, the primary object of the invention is to provide tea cubes for instant preparation of tea which has excellent quality in exciting flavour range.

Another object of the invention is to provide tea cubes which can be used both in hot and cold water to make tea and can replace tea bags.

A further object of the invention is to provide tea cubes which leave no or negligible residue for disposal.

Another object of the invention is to develop a formulation that can replicate the taste of black/green tea bag sensorial using only natural ingredients (like natural tea extract, cane sugar and natural flavours) and also run the same continuously on a commercial scale in a sugar cube forming machine.

Yet another object of the invention is to provide tea cubes which have long shelf life, can produce tea having similar level of taste as from teabags and offer greater convenience as compared to teabags.

How the foregoing objects are achieved will be clear from the following description. In this context it is clarified that the description provided is non-limiting and is only by way of explanation.

### SUMMARY OF THE INVENTION

A method for making tea cubes containing a blend of granular sugar, dry extract of either black or green teas, micronized tea and flavour comprises of the steps of: providing tea leaves that have been micronized in a jet mill to simulate performance of instant tea without contributing any stickiness; preparing sugar and flavour for mixing and incorporating them with micronized tea and deciding the particle size distribution of sugar depending upon the percentage (%) of non-sugar ingredients in the cube formulation.

The process of micronizing of tea leaves comprises of the steps of:

feeding the material into the vortex positioned along an engineered tangent circle of the jet mill, when the material accelerates; generating strong velocity gradients near the jet causing the suspended particles of the material to collide with each other and reduce themselves by attrition and collision; exiting the jet fluid through an outlet at the center of the grinding chamber either from top or bottom, drawing the micronized particles with it to a cyclone collection system; and holding the heavier oversized particles in the grinding chamber by centrifugal force, until micronized to a desired size.

The process of micronizing of tea leaves results in the high-velocity collisions between particles of the process material itself, no separate grinding media being involved.

The method for making tea cubes consists of: individually weighing sugar, instant tea, micronized tea and flavours as per the recipe; blending together instant tea, micronized tea and flavours using suitable blender to make a concentrate kit; loading required quantity of sugar into a coating pan; slowly dosing other ingredients in the concentrate kit into the coating pan; spraying a predetermined quantity between 1-3% of water on to this mixture using a spray nozzle; and feeding the whole mixture into a cube forming machine, once the mixture is homogenously blended and moistened.

The tea cube contains sugar in the range of 75-95% by weight, instant tea in the range of 3-10% by weight, micronized tea in the range of 3-10% by weight and flavours in the range of 1-5% by weight. The tea cube is instantly dissolvable both in hot water and cold water, each cube containing less than 16 calories and leaving no residue after use.

### BRIEF DESCRIPTION OF THE ACCOMPANYING DRAWINGS

The nature and scope of the present invention will be better understood from the accompanying drawings, which are by way of illustration of a preferred embodiment and not by way of any sort of limitation. In the accompanying drawings: —

FIG. 1 is a pictorial representation of the tea cubes according to the present invention.

FIG. 2 shows an overview of the equipment for micronizing tea.

FIG. 3 shows a jet mill used for the micronization of tea according to the present invention.

FIG. 4 shows the pulverization/micronization operation in details.

FIGS. 5a and 5b illustrate loading of sugar and other ingredients into the concentration kit.

### DETAILED DESCRIPTION OF THE INVENTION

Having described the main features of the invention above, a more detailed and non-limiting description of a preferred embodiment will be given in the following paragraphs with reference to the accompanying drawings.

All through the specification, the technical terms and abbreviations are to be interpreted in the broadest sense of the respective terms and include all similar items in the field known by other terms, as may be clear to persons skilled in art. Restriction or limitation if any referred to in the specification, is solely by way of example and understanding the present invention.

The instant invention provides an innovative medium called ‘Tea Cubes’ that can offer delicious taste of tea (in exciting flavor ranges), convenience, and portability in a unitized format, without any tea bags.

The general ingredients used in the formulations are a blend of granular sugar (as a carrier) with dry extract of either black or green teas and flavour to suit consumer preference.

The challenge in the present invention was to develop a formulation that can replicate the taste of black/green tea bag sensorial using only natural ingredients (like natural tea extract, cane sugar and natural flavours) and also run the same continuously on a commercial scale in a sugar cube forming machine. The formulation also has to be shelf stable.

This challenge was overcome by developing a process and product formulation by reducing the percentage of sticky/hygroscopic ingredients and replacing them with high-tech components which enabled the formulation deliver required sensorial factors and also run the formulation smoothly on a commercial cube forming machine.

### Technology

Tea cube as a product is unique and first of its kind in the global market. Manufacturing of tea cubes on a commercial scale using sugar cube machine may not have been tried anywhere in the global market. Tea cubes, if available anywhere, may have been produced manually and not using sugar cube machine.

Initial trials carried to manufacture tea cubes on a sugar cube machine did not yield the desired results owing to shortcomings in the formulation and the constraints in manufacturing process.

Technologies from adjacent categories like confectionary industry (Mold & Die method) and pharmaceutical industry (Dry Compaction method) industries were also explored to produce tea tablets. However, these methods didn't deliver on key attributes like instant dissolution. Usage of effervescent ingredients to address solubility issues were not allowed due to regulatory constraints.

Hence the formulation was further optimized to enable running the tea cubes on sugar cube machine.

Choice of Ingredients

Common ingredients used in tea cubes are a blend of sugar, dry extract of teas and flavour which are pressed in the form of a cube, weighing approx. 4 gms. Dry extract of tea (instant tea) is an essential ingredient in tea cube formulation to enable the quick dissolution of the product and also for tea colour and tea taste.

The ingredients in the formulation (particularly the dry extracts of tea and the powder flavours) are highly hygroscopic and are known to contribute to stickiness or form lumps and thus making it difficult to run them on a machine, on a continuous scale.

In order to reduce stickiness of formulation, there was a need to replace/reduce instant tea from the formulation and hence there was need to find an alternate ingredient that can mimic sensorial performance of Instant tea.

As a substitute for instant tea, micronized tea was invented as a component that can simulate performance of instant tea without contributing any stickiness. Micronized tea is rich in fibres and can even function as a lubricant. Thus, it facilitates running of formulation on the machine.

Though micronized teas can contribute to tea taste and mouthfeel, it adversely impacted the colour of the end cup. Hence, a suitable grade of instant tea was identified that can impart required colour at very minimal dosage.

An economic and technologically advanced route was identified for micronizing tea (through air jet mill technology), that reduces the particle size of tea granules to submicron sizes, thereby improving the polyphenol delivery and the tea character.

The uniqueness of the formulation developed by the applicants lies in the choice of ingredients and the technology deployed to manufacture tea cubes that can match sensorial of a tea bag and yet offer convenience.

Technology Component:

Tea character and colour in sugar cube is contributed by instant tea, which is a spray-dried product of water-soluble extracts from tea. This, however, is very hygroscopic and hence there was need to find an alternate which can simulate sensorial performance of instant tea.

Micronized tea was identified as a component which can mimic performance of instant tea without contributing any stickiness. Moreover, since micronized tea is rich in fibres, it can even function as a lubricant and thus facilitate running of the formulation on a commercial cube forming machine.

Micronization is a term used to describe size reduction where the resulting particle-size distribution is less than 20 microns. Jet mills are used for micronizing of solids of chemicals, pharmaceuticals, pigments, minerals and others like heat sensitive, corrosive and abrasive materials.

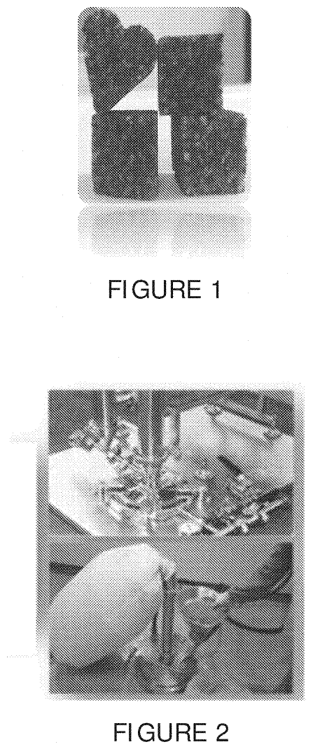

FIG. 1 is a pictorial representation of the tea cubes according to the present invention.

FIG. 2 shows an overview of the equipment for micronizing tea.

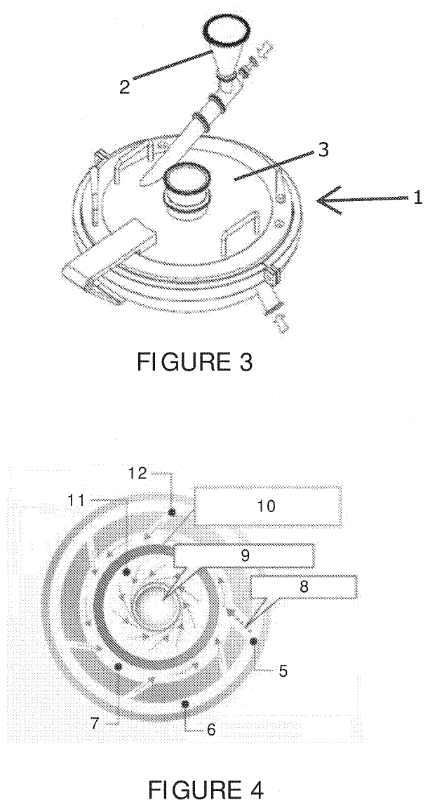

Reference is made to FIG. 3 showing a jet mill (1) used for the micronization of tea according to the present invention.

Jet mills operate with compressed air, gas or high pressure superheated steam. Jet mills have no moving parts, thereby eliminating contamination due to contact with external grinding media. It is also an ideal process to grind heat-sensitive and waxy material because no attrition heat is generated.

The jet mill works on fluid energy. Micronizing and classification take place in a shallow, cylindrical chamber. High pressure air or steam is injected in this chamber through the specially designed nozzles placed at regular distance, on the peripheral wall. The axis of each jet is tangential to the circumference of a smaller, imaginary, concentric circle.

Pulverisation of Tea Leaves:

Accompanying FIG. 4 shows the pulverization/micronization operation in detail. It shows the ejector (5), the compressed air reservoir (6) and the pulverizing zone (7). It also illustrates the raw material feeding line (8), the outlet of pulverized powder (9), the pulverizing classifying channel (10), the classifying zone (11) and the pulverizing nozzle (12).

During the pulverization process, the material is fed into the vortex (2) of the jet mill (1), best shown in FIG. 3, the vortex being positioned along an engineered tangent circle, when the material accelerates. Strong velocity gradients generated near the jet cause the suspended particles of the material to collide with each other and reduce themselves by attrition and collision. Size reduction is the result of the high-velocity collisions between particles of the process material itself. No separate grinding media is involved. The jet fluid exits through an outlet at the center of the grinding chamber (3) either from top or bottom and draws the micronized particles with it to a cyclone collection system. Heavier oversized particles are held in the grinding chamber by centrifugal force, until micronized to a desired size.

Comparison between regular tea and micronized tea is provided in the table 1 below:

TABLE 1

| Characteristic | Regular tea | Micronized tea |
|---|---|---|
| Particle size | 250μ-3000μ | 15-30μ |
| Colour of granule/powder | Brown to blackish | Green to Light brown |
| Color of brew | Clear solution | Hazy and Muddy in |
| | Green to black in color | color |

The advantages of micronized tea over regular tea are as follows:

a) It is smooth, non-gritty mouthfeel below particle size of less than 20 microns.
b) Increased soluble solids due to reduced particle size.
c) Enhanced polyphenol diffusion.

Preparing sugar and flavor for mixing and Incorporating with micronized tea:

No specific pre-treatment is involved either for sugar or other ingredients that are to be blended with micronized tea.

Depending upon the percentage (%) of non-sugar ingredients in the cube formulation, the particle size distribution of sugar is decided.

Either powder or liquid flavors or combination of both can be used in the formulation, depending upon the end cup sensorials required or % of non-sugar ingredients.

Shelf Life of the Tea Cube Thus Prepared:

Minimum shelf life has been found to be 12 months. The experimental data provided in Table 2 below will corroborate.

TABLE 2
Primary Packaging Material: laminate of 12μPET/7μFoil/40μpoly

| Attribute | Zero Day | After 12 months |
|---|---|---|
| Moisture content (%) | 0.5-0.6% | 1.2-1.3% |
| Sensory | — | Acceptable as against |
| | | Zero day sample |

Microbiological

| | | |
|---|---|---|
| TPC | <10 cfu/gm | <10 cfu/gm |
| Y&M | <10 cfu/gm | <10 cfu/gm |
| Escherichia coli | <10 cfu/gm | <10 cfu/gm |
| Coliform | <10 cfu/gm | <10 cfu/gm |
| Salmonella | Absent/25 gm | Absent/25 gm |
| Staphylococcus aureus | <10 cfu/gm | <10 cfu/gm |

Combining all the Ingredients of the Tea Cube Mixture Using the Sugar Cube Making Machine to Prepare the Desired Tea Cubes:

Sugar, Instant tea, micronized tea and flavours are individually weighed as per the recipe.

Instant tea, micronized tea and flavours are then blended together using suitable blender to make a concentrate kit.

Required quantity of sugar is loaded into a coating pan. Other ingredients in the concentrate kit are then slowly dosed into the coating pan. A predetermined quantity (1-3%) of water is then sprayed on to this mixture using a spray nozzle. Once the whole mixture is homogenously blended and moistened, it is then fed into a cube forming machine.

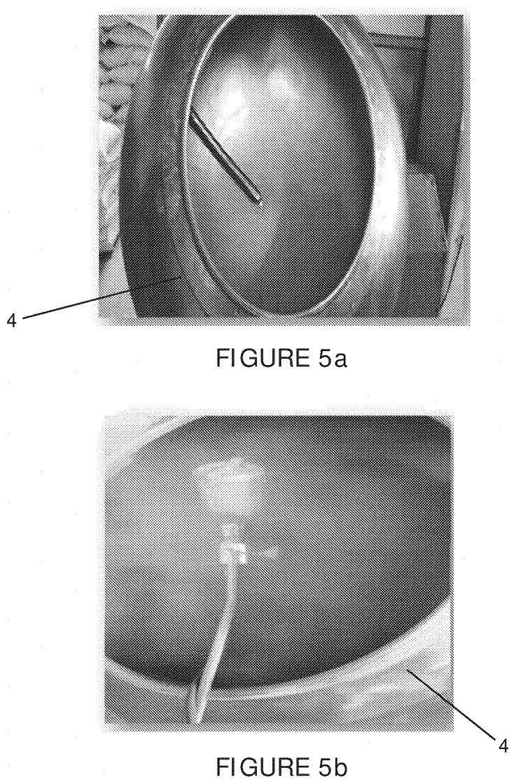

FIGS. 5a and 5b illustrate loading of sugar and other ingredients into the concentration kit.

Advantages of Tea Cubes as Deciphered Over Regular Tea:

Convenient and unitized format of tea

Can be prepared in hot or cold water

No mess to dispose

Delivers delicious taste matching that of tea bag

Sugar, Instant tea, micronized tea and flavours are individually weighed as per the recipe.

The range of percentage by weight of each ingredient applied in the tea cube, as arrived at by research and experimentation:
Sugar: 75-95%
Instant tea: 3-10%
Micronized tea: 3-10%
Flavours: 1-5%

Benefits of Micronization in Tea;
Reduced particle size gives increased surface area, resulting in better dispersion and diffusion.
Smooth, non-gritty mouthfeel when the particle size is <20 p.
Increases soluble solids by 25%.
Enhances polyphenol diffusion.

The above method of using technology components (micronized tea) in the tea cube formulation has the capacity to enable successful production of tea cubes on a commercial scale and meet the consumer expectation on sensory requirements.

The present invention also includes a tea kit comprising the tea cube of the present invention as described hereinbefore.

### Advantages

Some of the non-limiting advantages of the present invention are mentioned below. Other advantages will be clear to a person skilled in the art from the description provided above.
Tea cubes can produce tea without boiling water.
Have a long shelf-life and high portability.
Offer the simplest and quickest way to make tea.
Can produce tea in different exciting flavours.
Cold/iced tea can be prepared directly from tea cubes without first making hot tea.
Reduces time and labour required for preparation of tea.

The present invention has been described with reference to some drawings and a preferred embodiment purely for the sake of understanding and not by way of any limitation and the present invention includes all legitimate developments within the scope of what has been described herein before and claimed in the appended claims.

1. A method for making tea cubes containing a blend of granular sugar, dry extract of either black or green teas, micronized tea and flavor, the method comprising:
providing tea leaves that have been micronized in a jet mill to simulate performance of instant tea without contributing any stickiness;
preparing sugar and flavor for mixing and incorporating them with micronized tea; and
deciding the particle size distribution of sugar depending upon the percentage of non-sugar ingredients in the cube formulation.

2. The method for making tea cubes as claimed in claim 1,
wherein the process of micronizing of tea leaves comprises of the steps of:
feeding the material into the vortex positioned along an engineered tangent circle of the jet mill, when the material accelerates;
generating strong velocity gradients near the jet, causing the suspended particles of the material to collide with each other and reduce themselves by attrition and collision;
exiting the jet fluid through an outlet at the center of the grinding chamber either from top or bottom, drawing the micronized particles with it to a cyclone collection system; and
holding the heavier oversized particles in the grinding chamber by centrifugal force, until micronized to a desired size.

3. The method for making tea cubes as claimed in claim 1, wherein the process of micronizing of tea leaves results in high-velocity collisions between particles of the process material itself, no separate grinding media being involved.

4. The method for making tea cubes as claimed in claim 1, the method comprising:
individually weighing sugar, instant tea, micronized tea and flavors as per the recipe;
blending together instant tea, micronized tea and flavors using suitable blender to make a concentrate kit;
loading required quantity of sugar into a coating pan;
slowly dosing other ingredients in the concentrate kit into the coating pan;
spraying a predetermined quantity between 1-3% of water on to this mixture using a spray nozzle; and
feeding the whole mixture into a cube forming machine, once the mixture is homogenously blended and moistened.

5. The method for making tea cubes as claimed in claim 1, wherein the tea cube comprises sugar in the range of 75-95% by weight, instant tea in the range of 3-10% by weight, micronized tea in the range of 3-10% by weight and flavors in the range of 1-5% by weight, the tea cube being instantly dissolvable both in hot water and cold water, each cube containing less than 16 calories and leaving no residue after use.

6. A tea cube comprising:
sugar in the range of 75-95% by weight;
instant tea in the range of 3-10% by weight;
micronized tea in the range of 3-10% by weight;
flavors in the range of 1-5% by weight;
wherein the tea cube is instantly dissolvable both in hot water and cold water; and
wherein the tea cube contains less than 16 calories and leaves no residue after use.

7. A kit having a tea cube comprising:
sugar in the range of 75-95% by weight,
instant tea in the range of 3-10% by weight,
micronized tea in the range of 3-10% by weight;
flavors in the range of 1-5% by weight;
wherein the tea cube is instantly dissolvable both in hot water and cold water; and
wherein the tea cube contains less than 16 calories and leaves no residue after use.
